(19) United States
(12) Patent Application Publication
(10) Pub. No.: US 2022/0371116 A1
(43) Pub. Date: Nov. 24, 2022

(54) LOW MELTING NICKEL-MANGANESE-SILICON BASED BRAZE FILLER METALS FOR HEAT EXCHANGER APPLICATIONS

(71) Applicant: OERLIKON METCO (US) INC., Westbury, NY (US)

(72) Inventors: Dongmyoung LEE, Novi, MI (US); Subramaniam RANGASWAMY, Rochester Hills, MI (US)

(73) Assignee: OERLIKON METCO (US) INC., Westbury, NY (US)

(21) Appl. No.: 17/765,564

(22) PCT Filed: Nov. 25, 2020
(86) PCT No.: PCT/US2020/062261

§ 371 Date: Mar. 31, 2022

Related U.S. Application Data
(60) Provisional application No. 62/940,533, filed on Nov. 26, 2019.

(51) Int. Cl. B23K 1/00; B23K 35/02; B23K 35/22; B23K 35/30

(52) U.S. Cl. CPC B23K 1/0012; B23K 35/0222; B23K 35/22; B23K 35/3026; B23K 35/3033; B23K 2101/14

(57) ABSTRACT

Ni—Mn—Si based braze filler alloys or metals which may be nickel-rich, manganese-rich, or silicon-rich braze filler alloys, have unexpectedly narrow melting temperature ranges, low solidus and low liquidus temperatures, as determined by Differential Scanning calorimetry (DSC), while exhibiting good wetting, and spreading, without deleterious significant boride formation into the base metal, and can be brazed at lower temperatures. The nickel rich alloys contain 58 wt % to 70 wt % nickel, the manganese-rich alloys contain 55 wt % to 62 wt % manganese, and the silicon-rich alloys contain 25 wt % to 29 wt % silicon. Copper with or without boron to partly replace nickel may be employed without any substantial increase of the melting point, or to reduce the melting point. The braze filler alloys have sufficient brazability to withstand high temperature conditions for thin-walled aeronautical and other heat exchangers.

### CROSS-REFERENCE TO RELATED APPLICATION

This International Application claims the benefit of U.S. Provisional Application No. 62/940,533 filed Nov. 26, 2019, the disclosure of which is expressly incorporated by reference herein in its entirety.

### FIELD OF THE INVENTION

The present invention relates to low melting nickel-manganese-silicon based braze filler metals. The braze filler metals or alloys may be in the form of a powder, amorphous foil, atomized powder, paste, tape, or sintered preform, and may be employed in powder spray coatings with a binder for spraying applications, and screen printing pastes. The braze filler metals may be used for brazing of heat exchangers, or in the production of heat exchangers, such as for thin-walled heat exchangers used in the aeronautical industry, heat exchangers for air conditioners.

### BACKGROUND OF THE INVENTION

Nickel based filler metals have been used for brazing base metals such as stainless steels, alloy steels, carbon steels and nickel based superalloys. Ni—Cu—Mn—Si braze alloys are extensively used in the manufacture of heat exchangers for the Aerospace industry. The most well-known filler metal for this purpose is defined by the American Welding Society (AWS) as BNi-8. According to the AWS Brazing Handbook, 5^{th} ed. 2007, Chapter 3, page 86, BNi-8 has a composition of 62.5 wt % to 68.5 wt % Ni, 21.5 wt % to 24.5 wt % Mn, 6.0 wt % to 8.0 wt % Si, and 4.0 wt % to 5.0 wt % Cu, the weight percentages adding up to 100%. A conventional AWS specification BNi-8 type filler metal such as Oerlikon Metco AMDRY 930 is widely used in the Aerospace Industry for brazing thin walled plate heat exchangers. Amdry 930 has a nominal composition of bal. Ni, 24 wt % Mn, 7.0 wt % Si, and 5 wt % Cu, the weight percentages adding up to 100%. Amdry 930 does not contain boron, and it has a solidus of 1,033° C. and a liquidus of 1049° C.

Several other braze filler metals containing high amounts of boron (in the range of 2.75 to 3.5 wt %), for example BNi-1, 1a, 2, 3, 9, and 13, have desirable melting points comparable to Amdry 930; but are not suitable for brazing thin walled heat exchangers due to potential erosion problems and strength degradation from boron diffusion into the base metals For example, according to the AWS Brazing Handbook, BNi-2 has a composition of 62.5 wt % to 68.5 wt % Ni, 6.0 wt % to 8.0 wt % Cr, 4.0 wt % to 5.0 wt % Si, 2.5 wt % to 3.5 wt % Fe, and 2.75 wt % to 3.5 wt % B, the weight percentages adding up to 100%. Therefore high amounts of boron (in excess of 1 wt %) is not desirable from a strength point of view.

Commercially available nickel rich brazing alloys which do not contain boron include AMDRY 930 (bal. Ni, 24 wt % Mn, 7.0 wt % Si, and 5 wt % Cu), AMDRY 9301 (bal. Ni, 23 wt % Mn, 7.0 wt % Si, and 4.5 wt % Cu), AMDRY 9300B (bal. Ni, 22.5 wt % Mn, 7.0 wt % Si, and 4.75 wt % Cu).

A commercially available manganese rich brazing alloy which does not contain boron includes Advanced Technology & Materials Co., Ltd.'s (AT&M's) AT-MN70NiCr with a composition of 24.0 wt % to 26.0 wt % Ni, 4.5 wt % to 5.5 wt % Cr, and 68.5 wt % to 71.5 wt % Mn, (http://www.atmcn.com/index.php?a=shows&catid=838&id=2555), having a melting range of 1,035° C. to 1,080° C. A commercially available manganese rich brazing alloy which does contain boron is SAE MOBILUS's AMS 4780 with a composition of 66 wt % Mn, 16 wt % Ni, 16 wt % Co, and 0.80 wt % B, (https://www.sae.org/standards/content/ams4780) having a 966° C. to 1024° C. Solidus-Liquidus Range.

Notwithstanding the above, there is a strong desire to find braze filler metals with lower melting points compared to BNi-8 type compositions within the Ni—Cu—Mn—Si alloy system and which can be employed for brazing thin walled heat exchangers and which do not cause erosion or strength degradation of the base metals.

In contrast, to overcome the above problems, the present invention provides compositions around the true eutectic points in the Ni—Mn—Si ternary system with further improvements by controlled additions of copper and micro alloying with small amounts of boron. The compositions of the present invention have significantly lower melting points compared to BNi-8 type, so that heat exchangers with thin sheet metals, such as heat exchangers manufactured for the aerospace industry could be brazed at significantly lower temperatures. The Ni—Mn—Si-based braze filler alloys or metals of the present invention have unexpectedly narrow melting temperature ranges, low solidus temperatures, and low liquidus temperatures, even if two phases or peaks are present in the melting profile, as determined by Differential Scanning calorimetry (DSC), while exhibiting good wetting, and good spreading, without the deleterious effect of boron diffusion into the base metal. No, or very low amounts of boron are employed to avoid disadvantages of boron or boride formation. The braze filler metals or alloys may be in the form of a powder, amorphous foil, atomized powder, paste, tape, or sintered preform, and may be employed in powder spray coatings with a binder for spraying applications, and screen printing pastes. The braze filler metals may be used for brazing of heat exchangers, or in the production of heat exchangers, for example, thin-walled aeronautical heat exchangers, and air conditioner heat exchangers, and for heat exchangers. Additionally, brazing may be performed at low temperatures while achieving rapid melting of the filler metal on the base metal.

### SUMMARY OF THE INVENTION

In accordance with the present invention, Ni—Mn—Si based braze filler alloys or metals may be nickel-rich, manganese-rich, or silicon-rich braze filler alloys or metals. The Ni—Mn—Si based braze filler alloys or metals provide unexpectedly low melting points having liquidus temperatures less than 1060° C., a narrow melting range less than 85° C., with no or very low amounts of boron. Ni—Mn—Si based braze filler alloys or metals of the present invention comprise nickel, manganese, and silicon, and preferably copper. Micro-alloying with very small amounts of boron may optionally be employed to further improve brazeability and reduce melting points without deleterious embrittlement and erosion caused by boron diffusion into the base metal.

In embodiments of the present invention, the Ni—Mn—Si based braze filler alloy or metal may be:
A) a nickel-rich braze filler alloy comprising
   a) nickel in an amount of from 58 wt % to 70 wt %,
   b) manganese in an amount of from 26 wt % to 29 wt %,
   c) silicon in an amount of from 6 wt % to 8 wt %,
   d) copper in an amount of from 0 wt % to 7 wt %, and
   e) boron in an amount of from 0 wt % to 1 wt %,
      the percentages of a) to e) adding up to 100 wt %, and

wherein the nickel-rich braze filler alloy has at least one of:
a solidus temperature which is less than or equal to 1,040° C.,
a liquidus temperature which is less than or equal to 1,060° C., or
a melting range where the difference between the solidus temperature and the liquidus temperature is less than or equal to 100° C., or
B) a manganese-rich alloy comprising
   a) nickel in an amount of from 30 wt % to 45 wt %,
   b) manganese in an amount of from 55 wt % to 65 wt %,
   c) silicon in an amount of from 1 wt % to 5% wt %,
   d) copper in an amount of from 0 wt % to 7 wt %, and
   e) boron in an amount of from 0 wt % to 1 wt %,
      the percentages of a) to e) adding up to 100 wt %, and

wherein the manganese-rich braze filler alloy has at least one of:
a solidus temperature which is less than or equal to 990° C.,
a liquidus temperature which is less than or equal to 1,000° C., or
a melting range where the difference between the solidus temperature and the liquidus temperature is less than or equal to 50° C., or
C) a silicon-rich alloy comprising
   a) nickel in an amount of from 50 wt % to 65 wt %,
   b) manganese in an amount of from 8 wt % to 15 wt %,
   c) silicon in an amount of from 25 wt % to 29 wt %,
   d) copper in an amount of from 0 wt % to 8 wt %, and
   e) boron in an amount of from 0 wt % to 1 wt %,
      the percentages of a) to e) adding up to 100 wt %, and

wherein the silicon-rich braze filler alloy has at least one of:
a solidus temperature which is less than or equal to 930° C.,
a liquidus temperature which is less than or equal to 960° C., or
a melting range where the difference between the solidus temperature and the liquidus temperature is less than or equal to 85° C.

In aspects of the invention the Ni—Mn—Si based braze filler alloys or metals is a ternary system of nickel, manganese, and silicon. The Ni—Mn—Si based braze filler alloys or metals may be: a) a nickel-rich ternary braze filler alloy or metal Ni—Mn—Si, or b) a manganese-rich ternary braze filler alloy or metal Ni—Mn—Si, or c) a silicon-rich braze filler alloy or metal Ni—Mn—Si. The ternary Ni—Mn—Si alloys or metals have a very narrow melting range, for example, less than or equal to 25° C., approaching the melting behavior of a eutectic composition where the solidus and the liquidus temperatures are the same.

In aspects of the invention, the braze filler metals or alloys may be in the form of a powder, amorphous foil, atomized powder, paste, tape, or sintered preform.

The braze filler metals or alloys may be employed in powder spray coatings with a binder for spraying applications, and screen printing pastes.

In aspects of the invention, the braze filler metals or alloys may be used for repairing heat exchangers, or in the production of heat exchangers by brazing the exchanger with the Ni—Mn—Si-based braze filler metal or alloy. The braze filler alloys or metals may be used for brazing or production of heat exchangers, such as, thin-walled aeronautical heat exchangers, and air conditioner heat exchangers.

### BRIEF DESCRIPTION OF THE DRAWINGS

The present invention is further illustrated by the accompanying drawings wherein:

FIG. 1 is a Differential Scanning calorimetry curve exhibiting a single peak in a heating and cooling cycle illustrating a near true eutectic melting behavior, with a narrow melting range of 18° C., and the solidus temperature and liquidus temperature for a ternary 66.6Ni26.6Mn6.8Si nickel-rich braze filler alloy of Example 1 of the present invention.

FIG. 2 is a Differential Scanning calorimetry curve exhibiting a single peak in a heating and cooling cycle for a nickel-rich Ni—Mn—Si braze filler alloy containing copper but no boron, 60.9Ni26.5Mn6.8Si5.9Cu of Example 2 of the present invention.

FIG. 3 is a Differential Scanning calorimetry curve exhibiting a single peak in a heating and cooling cycle illustrating a near true eutectic melting behavior, with a narrow melting range of 16° C., and the solidus temperature and liquidus temperature for a ternary 39.5Ni58.0Mn2.5Si manganese-rich braze filler alloy of Example 6 of the present invention.

FIG. 4 is a Differential Scanning calorimetry curve exhibiting a single peak in a heating and cooling cycle for a manganese-rich Ni—Mn—Si braze filler alloy containing copper but no boron, 34.0Ni57.7Mn2.5Si5.8Cu, of Example 7 of the present invention.

FIG. 5 is a Differential Scanning calorimetry curve exhibiting a single peak in a heating and cooling cycle illustrating a near true eutectic melting behavior, with a narrow melting range of 19° C., and the solidus temperature and liquidus temperature for a ternary 62.3Ni11.0Mn26.7Si silicon-rich braze filler alloy of Example 9 of the present invention.

### DETAILED DESCRIPTION OF THE INVENTION

An alloy starts to melt at one temperature called the solidus, and is not completely melted until it reaches a second higher temperature, the liquidus. As used herein the solidus is the highest temperature at which an alloy is solid—where melting begins. As used herein, the liquidus is the temperature at which an alloy is completely melted. At temperatures between the solidus and liquidus the alloy is part solid, part liquid. As used herein, the difference between the solidus and liquidus is called the melting range. As used herein, the brazing temperature is the temperature at which the Ni—Mn—Si-based braze filler alloy is used to form a braze joint. It is preferably a temperature which is at or above the liquidus, but it is below the melting point of the base metal to which it is applied. The brazing temperature is preferably 25° C. to 50° C. higher than the liquidus temperature of the Ni—Mn—Si-based braze filler alloy.

The melting range is a useful gauge of how quickly the alloy melts. Alloys with narrow melting ranges flow more quickly and when melting at lower temperatures, provide quicker brazing times and increased production. Narrow melting range alloys generally allow base metal components to have fairly tight clearances, for example 0.002″.

Filler alloys having a wide melting range between the solidus and liquidus where the filler metal is part liquid and part solid, may be suitable for filling wider clearances, or “capping” a finished joint. However, while helpful in bridging gaps, slowly heating a wide melting range alloy can lead to an occurrence called liquation. Long heating cycles may cause some element separation where the lower melting constituents separate and flow first, leaving the higher melting components behind. Liquation is often an issue in furnace brazing because extended heating time required to get parts to brazing temperature may promote liquation. A filler metal with a narrow melting range is preferred for this application.

The solidus temperature, liquidus temperature, and melting range of the Ni—Mn—Si-based braze filler alloys are determined herein by Differential Scanning calorimetry (DSC) in accordance with the NIST practice guide, Boettinger, W. J. et al, “DTA and Heat-flux DSC Measurements of Alloy Melting and Freezing” National Institute of Standards and Technology, special Publication 960-15, November 2006, the disclosure of which is herein incorporated by reference in its entirety. In making the determinations, the individual metallic materials are mixed and melted to form an alloy, the resulting alloy is solidified, the solidified alloy is ground to form a powdered alloy, and then the powdered alloy is subjected to the DSC analysis. The liquidus and solidus temperatures are determined by the profiles of the second heatings, which provides for better conformity of the alloy to the shape of the crucible, and more accurate determinations as indicated, for example, at page 12 of the NIST practice guide. The DSC analysis is performed using a STA-449 DSC of Netzsch (Proteus Software) with a 10° C./min. heating rate from 700° C. to 1,100° C., or to a higher temperature as needed to exceed the liquidus temperature. From room temperature to 700° C., the differential scanning calorimeter heats at its faster programmed rate which usually takes about 20 minutes or about 35° C./min. The cooling rate employed for the DSC analysis from above the liquidus temperature back down to room temperature is also at 10° C./min, but other cooling rates may be used.

The present invention provides Ni—Mn—Si-based braze filler metals or alloys that have low melting points and have liquidus temperatures below 1060° C., preferable below 1040° C. They do not contain high amounts of boron which can cause significant erosion of base metals. The braze filler metals or alloys may be employed for brazing of heat exchangers, and other devices where, for example, brazing of thin base metals is needed, such as for thin-walled aeronautical heat exchangers, and air conditioner heat exchangers.

In embodiments of the invention, Ni—Mn—Si-based braze filler metals or alloys are provided which are at or very close to the true eutectic points of the Ni—Mn—Si ternary system, which is the temperature at which the melting and solidification occur at a single temperature for a pure element or compound, rather than over a range. It is believed that the Ni—Mn—Si ternary system has three true eutectics, one for the Ni-rich Ni—Mn—Si ternary system, one for the Mn rich Ni—Mn—Si ternary system, and one for the Si-rich Ni—Mn—Si ternary system. The true ternary eutectic points of the Ni—Mn—Si system are difficult to determine because the true ternary eutectic point must be determined using equilibrium conditions which can take days of testing to reach. In an aspect of the invention, after determining the lowest melting ternary eutectic point for each of the Ni-rich Ni—Mn—Si ternary system, the Mn rich Ni—Mn—Si ternary system, and the Si-rich Ni—Mn—Si ternary system, or as close to it as reasonably possible, as evidenced, for example, by a single peak in the DSC curve or a very narrow melting range, compositional adjustments are made with controlled additions of copper with or without boron to partly replace nickel without any substantial increase of the melting point, or to reduce the melting point.

Silicon reduces the melting temperatures, and it cannot be readily diffused into the base metal as is boron. However, if too much silicon is included, it may increase brittleness and increase the melting temperature. Nickel improves both mechanical strength and corrosion resistance. Copper improves wetting and molten metal flow characteristics. Manganese functions as a melting temperature suppressant. Micro-alloying with small amounts of boron enables further improvement in brazeability and melting points without the deleterious effect of significant boride formation into the base metal.

Reducing the solidus temperature and the liquidus temperature to narrow the melting range of the Ni—Mn—Si-based braze filler metals or alloys provides compositions which behave more like a eutectic composition where there is minimal difference between the solidus and the liquidus temperatures. The narrowed melting range provides alloys with liquidus temperatures in embodiments of the invention which are less than or equal to 1060° C., preferably less than or equal to 1040° C., more preferably less than or equal to 1020° C., most preferably less than or equal to 1,000° C., with good wetting and spreading capabilities.

In embodiments of the invention, the Ni—Mn—Si-based braze filler metals or alloys exhibit:
1. narrow melting temperature ranges of less than or equal to 100° C., for example less than or equal to 85° C., preferably less than or equal to 50° C., more preferably less than or equal to 25° C., and/or
2. low solidus temperatures of less than or equal to 1,040° C., preferably less than or equal to 1,030° C., more preferably less than or equal to 1,000° C., most preferably less than or equal to 950° C. and/or
3. low liquidus temperatures of less than or equal to 1,060° C., preferably less than or equal to 1040° C., more preferably less than or equal to 1020° C., most preferably less than or equal to 1000° C.,
   even if two phases or two peaks are present in the melting profile, as determined by Differential Scanning calorimetry (DSC).

### Nickel-Rich Braze Filler Alloys

In embodiments of the present invention, the Ni—Mn—Si based braze filler alloy or metal is a nickel-rich braze filler alloy comprising:
a) nickel in an amount of from 58 wt % to 70 wt %,
b) manganese in an amount of from 26 wt % to 29 wt %,
c) silicon in an amount of from 6 wt % to 8% wt %,
d) copper in an amount of from 0 wt % to 7 wt %, and
e) boron in an amount of from 0 wt % to 1 wt %,
   the percentages of a) to e) adding up to 100 wt %.

The nickel-rich braze filler alloy has at least one of:
1. a solidus temperature which is less than or equal to 1,040° C., or
2. a liquidus temperature which is less than or equal to 1,060° C., or
3. a melting range where the difference between the solidus temperature and the liquidus temperature is less than or equal to 100° C.

In an aspect of the present invention, the Ni—Mn—Si braze filler alloy is a nickel-rich ternary braze filler alloy Ni—Mn—Si wherein: a) the amount of nickel is from 64 wt % to 70 wt %, preferably from 66 wt % to 68 wt %, more preferably from 66 wt % to 67 wt %, b) the amount of manganese is 26 wt % to 29 wt %, preferably from 26 wt % to 27 wt %, more preferably from 26.3 wt % to 26.9 wt %, and c) the amount of silicon is 6 wt % to 8 wt %, preferably from 6.5 wt % to 7.5 wt %, more preferably from 6.6 wt % to 6.9 wt %, the percentages of [a)+b)+c)] adding up to 100 wt %. Also, the nickel-rich ternary braze filler alloy Ni—Mn—Si has at least one of:
1. a solidus temperature which is less than or equal to 1,040° C., or
2. a liquidus temperature which is less than or equal to 1,060° C., or
3. a melting range where the difference between the solidus temperature and the liquidus temperature is less than or equal to 40° C., preferably less than or equal to 20° C.

In another aspect of the present invention, where copper, with or without boron may be included with the nickel, manganese and silicon, the nickel-rich braze filler alloy comprises:
a) nickel in an amount of from 58 wt % to 70 wt %, preferably from 58 wt % to 62 wt %, more preferably from 58 wt % to 61.5 wt %,
b) manganese in an amount of from 26 wt % to 29 wt %, preferably from 26.5 wt % to 27.5 wt %,
c) silicon in an amount of from 6 wt % to 8 wt %, preferably from 6.6 wt % to 7.2 wt %,
d) copper in an amount of from 0 wt % to 7 wt %, preferably greater than 0 wt % but less than or equal to 7 wt %, preferably from 4 wt % to 6 wt %, more preferably from 4.3 wt % to 5.9 wt %, and
e) boron in an amount of from 0 wt % to 1 wt %, preferably greater than 0 wt % but less than 1 wt %, preferably from 0.1 wt % to 0.7 wt %, more preferably from 0.1 wt % to 0.5 wt %,
   the percentages of a) to e) adding up to 100 wt %.

The nickel-rich braze filler alloy containing copper without boron may have a liquidus temperature of less than 1060° C., preferably less than 1040° C. and has at least one of:
1. a solidus temperature which is less than or equal to 1,040° C., preferably less than or equal to 1,030° C., more preferably less than or equal to 1,025° C., or
2. a liquidus temperature which is less than or equal to 1,060° C., preferably less than or equal to 1,045° C., more preferably less than or equal to 1040° C., or
3. a melting range where the difference between the solidus temperature and the liquidus temperature is less than or equal to 40° C., preferably less than or equal to 20° C.

The nickel-rich braze filler alloy containing copper with boron may have at least one of:
1. a solidus temperature which is less than or equal to 1000° C., preferably less than or equal to 950° C., most preferably less than or equal to 920° C., or
2. a liquidus temperature which is less than or equal to 1030° C., preferably less than or equal to 1,010° C., more preferably less than or equal to 1,000° C., most preferably less than or equal to 980° C., or
3. a melting range where the difference between the solidus temperature and the liquidus temperature is less than or equal to 85° C., preferably less than or equal to 65° C., more preferably less than or equal to 35° C.

### Manganese-Rich Braze Filler Alloys

In embodiments of the present invention, the Ni—Mn—Si based braze filler alloy or metal is a manganese-rich braze filler alloy comprising:
a) nickel in an amount of from 30 wt % to 45 wt %, preferably from 32 wt % to 41 wt %,
b) manganese in an amount of from 55 wt % to 62 wt %, preferably from 57 wt % to 60 wt %,
c) silicon in an amount of from 1 wt % to 5 wt %, preferably from 2 wt % to 4 wt %,
d) copper in an amount of from 0 wt % to 7 wt %, preferably greater than 0 wt % but less than or equal to 7 wt %, preferably from 4 wt % to 6.5 wt %, and
e) boron in an amount of from 0 wt % to 1 wt %, preferably greater than 0 wt % but less than 1 wt %, preferably from 0.1 wt % to 0.7 wt %,
   the percentages of a) to e) adding up to 100 wt %.

The manganese-rich braze filler alloy may have at least one of:
1. a solidus temperature which is less than or equal to 990° C., preferably less than or equal to 980° C., more preferably less than or equal to 950° C., most preferably less than or equal to 925° C.,
2. a liquidus temperature which is less than or equal to 1,000° C., preferably less than or equal to 980° C., more preferably less than or equal to 950° C., or
3. a melting range where the difference between the solidus temperature and the liquidus temperature is less than or equal to 35° C., preferably less than or equal to 20° C.

In an aspect of the present invention, the Ni—Mn—Si braze filler alloy is a manganese-rich ternary braze filler alloy Ni—Mn—Si wherein: a) the amount of nickel is from 36 wt % to 42 wt %, b) the amount of manganese is 56 wt % to 62 wt %, and c) the amount of silicon is 1 wt % to 4 wt %, preferably from 2 wt % to 4 wt %, the percentages of [a)+b)+c)] adding up to 100 wt %.

Also, the manganese-rich ternary braze filler alloy Ni—Mn—Si has at least one of:
1. a solidus temperature which is less than or equal to 990° C., preferably less than or equal to 980° C.,
2. a liquidus temperature which is less than or equal to 1,000° C., preferably less than or equal to 995° C., or
3. a melting range where the difference between the solidus temperature and the liquidus temperature is less than or equal to 30° C., preferably less than or equal to 20° C.

### Silicon-Rich Braze Filler Alloys

In embodiments of the present invention, the Ni—Mn—Si based braze filler alloy or metal is a silicon-rich braze filler alloy comprising:
a) nickel in an amount of from 50 wt % to 65 wt %, preferably from 53 wt % to 63 wt %, more preferably from 55 wt % to 63 wt %,
b) manganese in an amount of from 8 wt % to 15 wt %, preferably from 10 wt % to 12 wt %,
c) silicon in an amount of from 25 wt % to 29 wt %, preferably from 25 wt % to 28 wt %,
d) copper in an amount of from 0 wt % to 8 wt %, preferably greater than 0 wt % but less than or equal to 8 wt %, preferably from 2 wt % to 8 wt %, more preferably from 3 wt % to 7 wt %, and
e) boron in an amount of from 0 wt % to 1 wt %, preferably greater than 0 wt % but less than 1 wt %, preferably from 0.1 wt % to 0.7 wt %, the percentages of a) to e) adding up to 100 wt %.

The silicon-rich braze filler alloy may have at least one of:
1. a solidus temperature which is less than or equal to 930° C., preferably less than or equal to 920° C., more preferably, less than or equal to 900° C.,
2. a liquidus temperature which is less than or equal to 960° C., preferably less than or equal to 940° C., more preferably less than or equal to 925° C., or
3. a melting range where the difference between the solidus temperature and the liquidus temperature is less than or equal to 85° C., preferably less than or equal to 50° C.

In an aspect of the present invention, the Ni—Mn—Si braze filler alloy is a silicon-rich ternary braze filler alloy Ni—Mn—Si wherein: a) the amount of nickel is from 59 wt % to 65 wt %, b) the amount of manganese is 8 wt % to 14 wt %, and c) the amount of silicon is 25 wt % to 29 wt %, the percentages of [a)+b)+c)] adding up to 100 wt %.

Also, the silicon-rich ternary braze filler alloy Ni—Mn—Si has at least one of:
1. a solidus temperature which is less than or equal to 930° C., preferably less than or equal to 920° C.,
2. a liquidus temperature which is less than or equal to 960° C., preferably less than or equal to 940° C., or
3. a melting range where the difference between the solidus temperature and the liquidus temperature is less than or equal to 40° C., preferably less than or equal to 20° C.

In embodiments of the invention, the Ni—Mn—Si-based braze filler alloy or metal may be manufactured in the form of a powder, an amorphous foil, an atomized powder, a paste based on the powder, a tape based on the powder, sintered preforms, a powder spray coating with a binder, or a screen printing paste. Ni—Mn—Si-based braze filler alloy or metal may be applied by spraying, or by screen printing.

In an additional aspect of the invention, a method is provided for producing or repairing a heat exchanger by brazing the exchanger with the Ni—Mn—Si-based braze filler alloy or metal having liquidus temps less than 1060, 1040, 1020, and 1000° C.

The Ni—Mn—Si-based braze filler alloy or metal may be made using conventional methods for producing braze filler alloys or metals. For example, as conventional in the art, all of the elements or metals in the correct proportions may be mixed together and melted to form a chemically homogenous alloy which is atomized into a chemically homogeneous alloy powder. The particle size of the Ni—Mn—Si-based braze filler alloy or metal may depend upon the brazing method employed. Conventional particle size distributions conventionally employed with a given brazing method may be used with the Ni—Mn—Si-based braze filler alloy or metal of the present invention.

The base metal which is brazed with the Ni—Mn—Si-based braze filler alloy or metal may be any known or conventional material or article in need of brazing. Non-limiting examples of the base metal include alloys, or superalloys used in the manufacture of heat exchangers and other devices where, for example, brazing of thin base metals is needed, such as for thin-walled aeronautical heat exchangers, and air conditioner heat exchangers. Other non-limiting examples of known and conventional base metals which may be brazed with the Ni—Mn—Si-based braze filler alloy or metal of the present invention include carbon steel and low alloy steels, nickel and nickel base super alloys, stainless steel, and tool steels.

The present invention is further illustrated by the following non-limiting examples where all parts, percentages, proportions, and ratios are by weight, all temperatures are in ° C., and all pressures are atmospheric unless otherwise indicated:

### EXAMPLES

Examples 1-11 relate to Ni—Mn—Si-based braze filler alloys or metals of the present invention based upon a ternary Ni—Mn—Si system, with additions of Cu alone, and Cu and B alone. Examples 1-5 relate to nickel-rich braze filler alloys, Examples 6-8 relate to manganese-rich braze filler alloys, and Examples 9-11 relate to silicon-rich braze filler alloys. Comparative Example 1 relates to Amdry 930, a BNi-8 type nickel-based braze filler alloy which is a Ni—Mn—Si—Cu nickel based braze filler alloy which does not contain B. Comparative Examples 2 and 3 relate to manganese-rich braze filler alloys which do not contain silicon or copper, but contain Cr, or contain Co and B. The compositions of the Ni—Mn—Si-based braze filler alloys or metals of the present invention (Examples 1-11) and the comparative Ni-based and Mn-based braze filler alloys or metals (Comparative Examples 1-3) with their solidus temperature, liquidus temperature and melting range, all determined by DSC in the same manner using the STA 449(DSC) of Netzsch, using a heating rate and a cooling rate of 10° C./min are shown in Table 1:

TABLE 1
Melting temperature of low melting Ni—Mn—Si(Cu, B) alloys

| | | | | | | | | | | | Melting |
|---|---|---|---|---|---|---|---|---|---|---|---|
| | | Composition (wt %) | | | | | | | M.P.(^{o} C.) | | (° C.) |
| Example No. | | Ni | Mn | Si | Cu | B | Cr | Co | Solidus | Liquidus | Range |
| Ni Rich | (1) | 66.6 | 26.6 | 6.8 | — | — | — | — | 1038 | 1056 | 18 |
| | (2) | 60.9 | 26.5 | 6.8 | 5.9 | — | — | — | 1025 | 1039 | 14 |
| | (3) | 61.1 | 27.1 | 6.9 | 4.8 | 0.1 | — | — | 975 | 1009 | 34 |
| | (4) | 60.9 | 27.1 | 6.9 | 4.8 | 0.3 | — | — | 906 | 990 | 84 |
| | (5) | 60.7 | 27.1 | 6.9 | 4.8 | 0.5 | — | — | 916 | 978 | 62 |
| Mn Rich | (6) | 39.5 | 58.0 | 2.5 | — | — | — | — | 977 | 993 | 16 |
| | (7) | 34.0 | 57.7 | 2.5 | 5.8 | - | — | — | 948 | 966 | 18 |
| | (8) | 32.1 | 59.0 | 2.6 | 5.9 | 0.5 | — | — | 910 | 931 | 21 |
| Si Rich | (9) | 62.3 | 11.0 | 26.7 | — | — | — | — | 915 | 934 | 19 |
| | (10) | 55.6 | 10.9 | 26.6 | 7.0 | — | — | — | 880 | 947 | 67 |
| | (11) | 56.0 | 11.0 | 25.5 | 7.1 | 0.5 | — | — | 870 | 906 | 36 |

| | | | | | | | | | | |
|---|---|---|---|---|---|---|---|---|---|---|
| Comparative 1 | 64.0 | 24.0 | 7.0 | 5.0 | — | — | — | — | 1049 | 16 |
| Amdry 930 | | | | | | | | | | |
| (BNi-8 type) | | | | | | | | | | |
| Comparative 2 | 24.0 to | 68.5 to | — | — | — | 4.5 | — | 1035 | 1080 | 45 |
| ATM's | 26.0 | 71.5 | | | | to | | | | |
| AT-MN70NiCr | | | | | | 5.5 | | | | |
| Comparative 3 | 16 | 66 | — | — | 0.80 | — | 16 | 966 | 1024 | 58 |
| SAE MOBILUS | | | | | | | | | | |
| AMS 4780 | | | | | | | | | | |

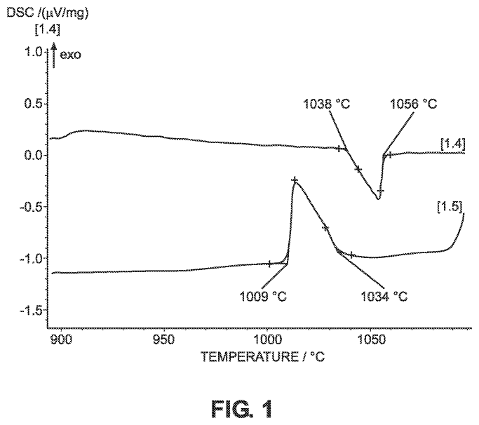

Example 1 is a ternary 66.6Ni26.6Mn6.8Si6.8 nickel-rich braze filler alloy of the present invention. As shown in FIG. 1, the Differential Scanning calorimetry curve for the ternary alloy of Example 1 exhibits a single peak in a heating and cooling cycle indicating a near true eutectic melting behavior, with a narrow melting range of 18° C., and a solidus temperature of 1,038° C. and a liquidus temperature of 1,056° C. The data listed in Table 1 show that the ternary 66.6Ni26.6Mn6.8Si nickel-rich braze filler alloy of the present invention which does not contain copper or boron, has only a slightly higher solidus temperature and liquidus temperature, and slightly higher melting range compared to the 1033° C. solidus temperature, 1049° C. liquidus temperature, and 16° C. melting range of the Amdry 930, Comparative Example 1, nickel-based brazing alloy which contains copper.

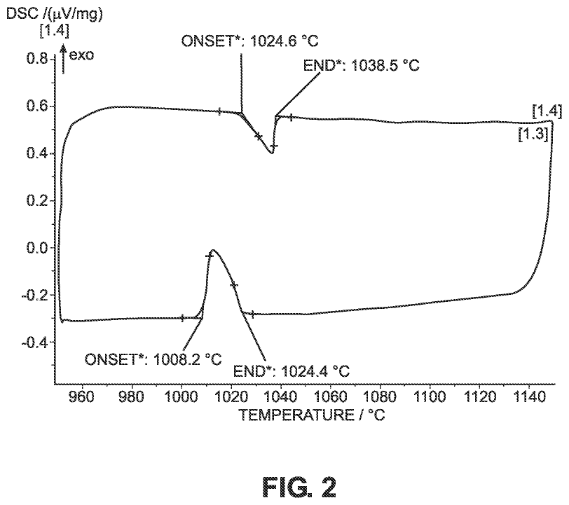

In Example 2, copper replaces a portion of the nickel in the ternary nickel-rich braze filler alloy of Example 1 to provide a 60.9Ni26.5Mn6.8Si5.9Cu nickel-rich braze filler alloy of the present invention which does not contain boron. As shown in FIG. 2, the Differential Scanning calorimetry curve exhibits a single peak in a heating and cooling cycle for the nickel-rich Ni—Mn—Si braze filler alloy containing copper but no boron, 60.9Ni26.5Mn6.8Si5.9Cu, of Example 2 of the present invention. As shown in FIG. 2 and in Table 1, the Example 2 nickel-rich braze filler alloy of the present invention exhibits a narrow melting range of 14° C., and a solidus temperature of 1,025° C. and a liquidus temperature of 1,039° C., each of which are, respectively, unexpectedly lower than the 1033° C. solidus temperature, 1049° C. liquidus temperature, and 16° C. melting range of the Amdry 930 in Comparative Example 1.

In Examples 3-5, copper and a very small amount of boron replaces a portion of the nickel in the ternary nickel-rich braze filler alloy of Example 1 to substantially lower the solidus and liquidus temperatures with an increase in the melting range of the nickel-rich braze filler alloy of the present invention. The data listed in Table 1 shows that the nickel rich braze filler alloys of Examples 3-5 exhibit: a) unexpectedly low solidus temperatures of less than or equal to 975° C., ranging from 906° C. to 975° C., b) unexpectedly low liquidus temperatures of less than or equal to 1,009° C., ranging from 978° C. to 1,009° C.

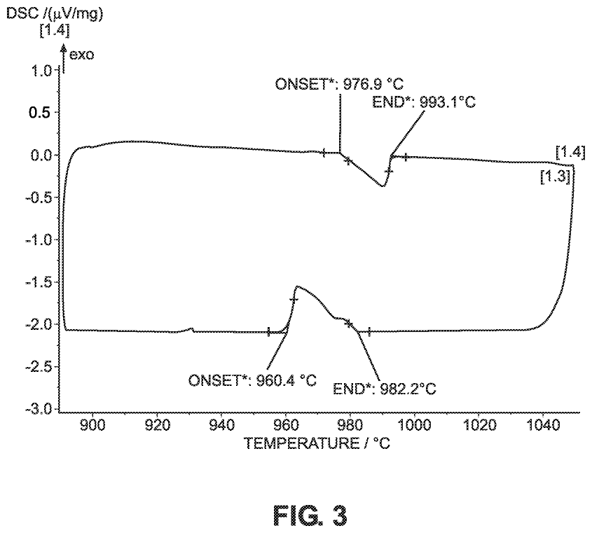

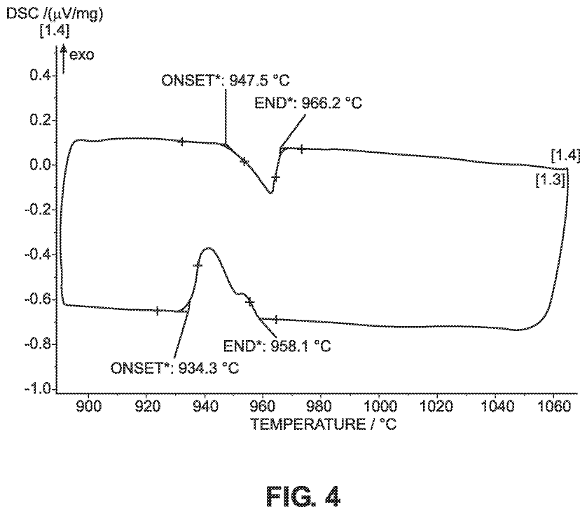

As shown in FIG. 3, the Differential Scanning calorimetry curve for the ternary manganese-rich alloy of Example 6 exhibits a single peak in a heating and cooling cycle indicating a near true eutectic melting behavior, with a narrow melting range of 16° C., and a solidus temperature of 977° C. and a liquidus temperature of 993° C. In Example 7, copper replaces a portion of the nickel in the ternary manganese-rich braze filler alloy of Example 6 to provide a 34.0Ni57.7Mn2.5Si5.8Cu manganese-rich braze filler alloy of Example 7 of the present invention which does not contain boron. As shown in FIG. 4, the Differential Scanning calorimetry curve for the manganese-rich alloy of Example 7 exhibits a single peak in a heating and cooling cycle, with a narrow melting range of 18° C., and a solidus temperature of 948° C. and a liquidus temperature of 966° C., each of which, respectively, are lower than those of the ternary manganese-rich alloy of Example 6. In Example 8, copper and a very small amount of boron replaces a portion of the nickel in the ternary manganese-rich braze filler alloy of Example 6 to substantially lower the solidus temperature to 910° C. and substantially lower the liquidus temperature to 931° C. with only a 5° C. increase in the melting range of the manganese-rich braze filler alloy of the present invention.

The data listed in Table 1 show that the manganese-rich braze filler alloys of the present invention, Examples 6-8 exhibit: a) unexpectedly low solidus temperatures of less than or equal to 977° C., ranging from 910° C. to 977° C., b) unexpectedly low liquidus temperatures of less than or equal to 993° C., ranging from 931° C. to 993° C., c) unexpectedly low melting ranges of less than or equal to 21° C., the melting ranges ranging from 16° C. for Example 6 to 21° C. for Example 8. In manganese-rich Comparative Examples 2 and 3, the solidus temperatures range from 966° C. to 1035° C., the liquidus temperatures range from 1024° C. to 1080° C., the melting ranges range from 45° C. to 58° C., For Comparative Example 2, which does not contain boron, the solidus temperature is from 58° C. to 87° C. higher, the liquidus temperature is from 87° C. to 114° C. higher, and the melting range is from 27° C. to 29° C. higher than for the manganese-rich braze filler alloys of Examples 6 and 7 which do not contain boron. For Comparative Example 3, which does contain boron, the solidus temperature is 56° C. higher, the liquidus temperature is 93° C. higher, and the melting range is 37° C. higher than for the manganese-rich braze filler alloy of Example 8 which contains boron.

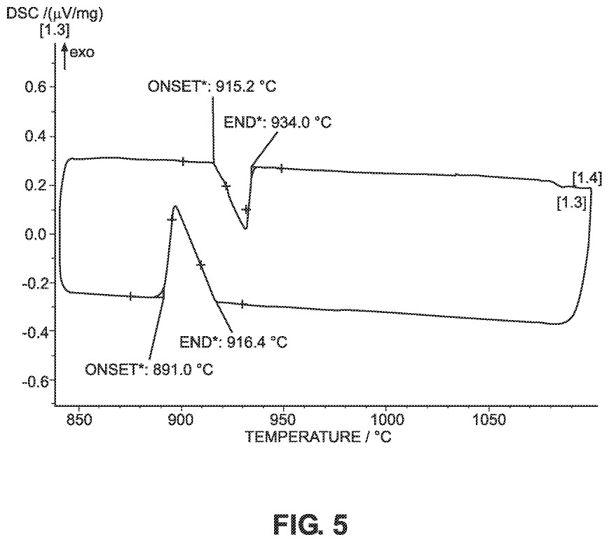

Example 9 is a ternary 62.3Ni11.0Mn26.7Si silicon-rich braze filler alloy of the present invention. As shown in FIG. 5, the Differential Scanning calorimetry curve for the ternary alloy of Example 9 exhibits a single peak in a heating and cooling cycle indicating a near true eutectic melting behavior, with a narrow melting range of 19° C., and a solidus temperature of 915° C. and a liquidus temperature of 934° C. In Example 10, copper replaces a portion of the nickel in the ternary silicon-rich braze filler alloy of Example 9 to provide a 55.6Ni10.9Mn26.6Si7.0Cu silicon-rich braze filler alloy of the present invention which does not contain boron, to substantially lower the solidus temperature to 880° C., but raises the liquidus temperature to 947° C. and increases the melting range to 67° C. for the silicon-rich braze filler alloy of the present invention. In Example 11, copper and a very small amount of boron replace a portion of the nickel in the ternary silicon-rich braze filler alloy of Example 9 to substantially lower the solidus temperature to 870° C. and substantially lower the liquidus temperature to 906° C. with a 17° C. increase in the melting range of the silicon-rich braze filler alloy of the present invention.

Further, at least because the invention is disclosed herein in a manner that enables one to make and use it, by virtue of the disclosure of particular exemplary embodiments, such as for simplicity or efficiency, for example, the invention can be practiced in the absence of any step, additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An Ni—Mn—Si-based braze filler alloy comprising:
A) a nickel-rich braze filler alloy comprising
a) nickel in an amount of from 58 wt % to 70 wt %,
b) manganese in an amount of from 26 wt % to 29 wt %,
c) silicon in an amount of from 6 wt % to 8% wt %,
d) copper in an amount of from 0 wt % to 7 wt %, and
e) boron in an amount of from 0 wt % to 1 wt %,
the percentages of a) to e) adding up to 100 wt %, and
wherein the nickel-rich braze filler alloy has at least one of:
a solidus temperature which is less than or equal to 1,040° C.,
a liquidus temperature which is less than or equal to 1,060° C., or
a melting range where the difference between the solidus temperature and the liquidus temperature is less than or equal to 100° C., or
B) a manganese-rich alloy comprising
a) nickel in an amount of from 30 wt % to 45 wt %,
b) manganese in an amount of from 55 wt % to 62 wt %,
c) silicon in an amount of from 1 wt % to 5% wt %,
d) copper in an amount of from 0 wt % to 7 wt %, and
e) boron in an amount of from 0 wt % to 1 wt %,
the percentages of a) to e) adding up to 100 wt %, and
wherein the manganese-rich braze filler alloy has at least one of:
a solidus temperature which is less than or equal to 990° C.,
a liquidus temperature which is less than or equal to 1,000° C., or
a melting range where the difference between the solidus temperature and the liquidus temperature is less than or equal to 50° C., or
C) a silicon-rich alloy comprising
a) nickel in an amount of from 50 wt % to 65 wt %,
b) manganese in an amount of from 8 wt % to 15 wt %,
c) silicon in an amount of from 25 wt % to 29% wt %,
d) copper in an amount of from 0 wt % to 8 wt %, and
e) boron in an amount of from 0 wt % to 1 wt %,
the percentages of a) to e) adding up to 100 wt %, and
wherein the silicon-rich braze filler alloy has at least one of:
a solidus temperature which is less than or equal to 930° C.,
a liquidus temperature which is less than or equal to 960° C., or
a melting range where the difference between the solidus temperature and the liquidus temperature is less than or equal to 85° C.

2. The Ni—Mn—Si braze filler alloy as claimed in claim 1 which is a nickel-rich ternary braze filler alloy Ni—Mn—Si wherein the amount of nickel is from 64 wt % to 70 wt %, the amount of manganese is 26 wt % to 29 wt %, and the amount of silicon is 6 wt % to 8 wt % the percentages of [a)+b)+c)] adding up to 100 wt %, and said melting range is less than or equal to 40° C.

3. The Ni—Mn—Si-based braze filler alloy as claimed in claim 1, which is a nickel-rich braze filler alloy wherein:
a) the amount of nickel is from 58 wt % to 63.5 wt %,
b) the amount of manganese is from 26 wt % to 29 wt %,
c) the amount of silicon is from 6 wt % to 8 wt %,
d) the amount of copper is from 4 wt % to 6 wt %, and
e) the amount of boron is from 0 wt % to 1 wt %,
the percentages of a) to e) adding up to 100 wt %, and
wherein the nickel-rich braze filler alloy has at least one of:
a solidus temperature which is less than or equal to 1,030° C.,
a liquidus temperature which is less than or equal to 1,040° C., or
a melting range where the difference between the solidus temperature and the liquidus temperature is less than or equal to 85° C.

4. The Ni—Mn—Si-based braze filler alloy as claimed in claim 3 wherein no boron is present and the percentages of a) to d) add up to 100 wt %.

5. The Ni—Mn—Si-based braze filler alloy as claimed in claim 1, which is a nickel-rich braze filler alloy wherein:
a) the amount of nickel is from 58 wt % to 63.5 wt %,
b) the amount of manganese is from 26 wt % to 29 wt %,
c) the amount of silicon is from 6 wt % to 8 wt %,
d) the amount of copper is from 4 wt % to 6 wt %, and
e) the amount of boron is greater than 0 wt % but less than 1 wt %,
the percentages of a) to e) adding up to 100 wt %, and
wherein the nickel-rich braze filler alloy has at least one of:
a solidus temperature which is less than or equal to 1,000° C., or
a liquidus temperature which is less than or equal to 1030° C.

6. The Ni—Mn—Si-based braze filler alloy as claimed in claim 5 which is a nickel-rich braze filler alloy wherein the amount of boron is from 0.1 wt % to 0.7 wt %, the percentages of a) to e) adding up to 100 wt %.

7. The Ni—Mn—Si-based braze filler alloy as claimed in claim 6 which is a nickel-rich braze filler alloy wherein the amount of boron is from 0.1 wt % to 0.5 wt %, the percentages of a) to e) adding up to 100 wt %, and
wherein the nickel-rich braze filler alloy has at least one of:
a solidus temperature which is less than or equal to 950° C. or
a liquidus temperature which is less than or equal to 1010° C.

8. The Ni—Mn—Si-based braze filler alloy as claimed in claim 6 which is a nickel-rich braze filler alloy wherein:
a) the amount of nickel is from 58 wt % to 62 wt %,
b) the amount of manganese is from 26.5 wt % to 27.5 wt %,
c) the amount of silicon is from 6.6 wt % to 7.2 wt %,
d) the amount of copper is from 4 wt % to 6 wt %, and
e) the amount of boron is from 0.1 wt % to 0.5 wt %,
the percentages of a) to e) adding up to 100 wt %.

9. The Ni—Mn—Si-based braze filler alloy as claimed in claim 8 which is a nickel-rich braze filler alloy wherein the solidus temperature is less than or equal to 920° C.

10. The Ni—Mn—Si-based braze filler alloy as claimed in claim 8 which is a nickel-rich braze filler alloy wherein the liquidus temperature is less than or equal to 980° C.

11. The Ni—Mn—Si-based braze filler alloy as claimed in claim 1, wherein the solidus temperature is less than or equal to 975° C. and/or the liquidus temperature is less than or equal to 1,000° C.

12. The Ni—Mn—Si-based braze filler alloy as claimed in claim 1, wherein the solidus temperature is less than or equal to 950° C.

13. The Ni—Mn—Si-based braze filler alloy as claimed in claim 1, which is a manganese-rich braze filler alloy or a silicon-rich braze filler alloy.

14. The Ni—Mn—Si-based braze filler alloy as claimed in claim 1, which is a manganese-rich braze filler alloy.

15. The Ni—Mn—Si braze filler alloy as claimed in claim 14 which is a manganese-rich ternary braze filler alloy Ni—Mn—Si wherein the amount of nickel is from 36 wt % to 42 wt %, the amount of manganese is 56 wt % to 62 wt %, and the amount of silicon is 1 wt % to 4 wt % the percentages of [a)+b)+c)] adding up to 100 wt %, and said melting range is less than or equal to 50° C.

16. The Ni—Mn—Si-based braze filler alloy as claimed in claim 14 which is a manganese-rich braze filler alloy wherein:
a) the amount of nickel is from 30 wt % to 45 wt %,
b) the amount of manganese is from 55 wt % to 62 wt %,
c) the amount of silicon is from 1 wt % to 5 wt %,
d) the amount of copper is from 4 wt % to 6.5 wt %, and
e) the amount of boron is from 0 wt % to 1 wt %,
the percentages of a) to e) adding up to 100 wt %, and
wherein the manganese-rich braze filler alloy has at least one of:
a solidus temperature which is less than or equal to 990° C.,
a liquidus temperature which is less than or equal to 1,000° C., or
a melting range where the difference between the solidus temperature and the liquidus temperature is less than or equal to 35° C.

17. The Ni—Mn—Si-based braze filler alloy as claimed in claim 16 which is a manganese-rich braze filler alloy wherein the amount of boron is greater than 0 wt % and less than 1 wt %, the percentages of a) to e) adding up to 100 wt %.

18. The Ni—Mn—Si-based braze filler alloy as claimed in claim 16 which is a manganese-rich braze filler alloy wherein the amount of boron is from 0.1 wt % to 0.7 wt %, the percentages of a) to e) adding up to 100 wt %.

19. The Ni—Mn—Si-based braze filler alloy as claimed in claim 16 which is a manganese-rich braze filler alloy:
wherein the amount of nickel is from 32 wt % to 41 wt %, the amount of manganese is from 57 wt % to 60 wt %, the amount of silicon is from 2 wt % to 4 wt %, the amount of copper is from 4 wt % to 6.5 wt %, and the amount of boron is from 0.1 wt % to 0.7 wt %, the percentages of a) to e) adding up to 100 wt %,
wherein the solidus temperature is less than 950° C., and
wherein the inciting range where the difference between the solidus temperature and the liquidus temperature is less than or equal to 35° C.

20. The Ni—Mn—Si braze filler alloy as claimed in claim 1, which is a silicon-rich braze filler alloy.

21. The Ni—Mn—Si-based braze filler alloy as claimed in claim 20 which is a silicon-rich ternary braze filler alloy Ni—Mn—Si wherein the amount of nickel is from 59 wt % to 65 wt %, the amount of manganese is 8 wt % to 14 wt %, and the amount of silicon is 25 wt % to 29 wt % the percentages of [a)+b)+c)] adding up to 100 wt %, and said melting range is less than or equal to 40° C.

22. The Ni—Mn—Si-based braze filler alloy as claimed in claim 20 which is a silicon-rich braze filler alloy wherein:
a) the amount of nickel is from 50 wt % to 65 wt %,
b) the amount of manganese is from 8 wt % to 15 wt %,
c) the amount of silicon is from 25 wt % to 29 wt %,
d) the amount of copper is from 2 wt % to 8 wt %, and
e) the amount of boron is from 0 wt % to 1 wt %,
the percentages of a) to e) adding up to 100 wt %/o, and
wherein the silicon-rich braze filler alloy has at least one of:
a solidus temperature which is less than or equal to 930° C.,
a liquidus temperature which is less than or equal to 960° C., or
a melting range where the difference between the solidus temperature and the liquidus temperature is less than or equal to 85° C.

23. The Ni—Mn—Si-based braze filler alloy as claimed in claim 22 which is a silicon-rich braze filler alloy wherein the amount of boron is greater than 0 wt % and less than 1 wt %, the percentages of a) to e) adding up to 100 wt %.

24. The Ni—Mn—Si-based braze filler alloy as claimed in claim 22 which is a silicon-rich braze filler alloy wherein the amount of boron is from 0.1 wt % to 0.7 wt %, the percentages of a) to e) adding up to 100 wt %.

25. The Ni—Mn—Si-based braze filler alloy as claimed in claim 22 which is a silicon-rich braze tiller alloy:
wherein the amount of nickel is from 53 wt % to 63 wt %, the amount of manganese is from 10 wt % to 12 wt %, the amount of silicon is from 25 wt % to 28 wt %, the amount of copper is from 2 wt % to 8 wt %, and the amount of boron is from 0.1 wt % to 0.7 wt %, the percentages of a) to e) adding up to 100 wt %,
wherein the solidus temperature is less than or equal to 920° C., and
wherein the liquidus temperature is less than or equal to 940° C.

26. The Ni—Mn—Si-based braze filler alloy as claimed in claim 1, which is in the form of a powder, amorphous foil, atomized powder, paste, tape, or sintered preform.

27. A powder spray coating comprising the Ni—Mn—Si-based braze filler alloy as claimed in claim 1 and a binder.

28. A heat exchanger comprising an Ni—Mn—Si-based braze filler alloy as claimed in claim 1.

29. A heat exchanger as claimed in claim 28, which is a thin-walled aeronautical heat exchanger, or an air conditioner heat exchanger.

30. A method for producing or repairing a heat exchanger comprising brazing the exchanger with an Ni—Mn—Si-based braze filler alloy as claimed in claim 1.
